(19) United States
(12) Patent Application Publication
(10) Pub. No.: US 2018/0035676 A1
(43) Pub. Date: Feb. 8, 2018

(54) Compact Machine for Manufacturing Injera

(71) Applicant: Yilma ASFAW, BELLAIRE, TX (US)

(72) Inventor: Yilma ASFAW, BELLAIRE, TX (US)

(73) Assignee: YILMA ASFAW, BELLAIRE, TX (US)

(21) Appl. No.: 15/434,060

(22) Filed: Feb. 16, 2017

Related U.S. Application Data
(63) Continuation of application No. 62/296,035, filed on Feb. 16, 2016.

(51) Int. Cl. A21B 5/00; A21B 7/00; A21C 9/08; A21D 8/06

(52) U.S. Cl. CPC A21B 5/00; A21D 8/06; A21B 7/00; A21C 9/081

(57) ABSTRACT

A machine for manufacturing of flatbread, mainly Ethiopian Injera, sometimes known as Enjera. The machine comprises of batter dispensing unit, baking pans, lid carrier unit, pan rotating unit, protection covers, heat supply unit, top support unit, and bottom support unit. The batter dispenser has nozzles with flow control mechanism. The baking pan is rectangular shaped with concave shape lid to cover pan the baking surface. The machine has two configurations: rotary pans configuration and stationary pans configuration. In rotary pans configuration, the pans rotates and in stationary pans configuration, the pans are stationary and the batter dispensing unit moves to each pan to dispense batter.

### TECHNICAL FIELD

This invention relates to an automated manufacturing machine for the manufacturing of flatbread mainly Injera also known as Enjera. The same machine can be used to manufacture flatbread such as crepe, Chinese flatbread, Indian flatbread etc.

### BACKGROUND OF THE INVENTION

Injera is a flatbread which is circular, thin widely known in Ethiopia and some neighboring countries. Sometimes it may be called Enjera. It is a spongy, vesicular textured, sour test flatbread. It is usually made of teff flour in Ethiopia. Teff is the smallest gain grown mainly in Ethiopia. Nowadays, Ethiopian community in developed countries started adding wheat/self-rising, barley flours in the teff batter.

For centuries most Ethiopians bake Injera on a hot hand-made clay pan using wood as a source of heat. Some people started using clay pans and small size metal cooking pans coated with non-stick coat to bake Injera using electric heaters as source of heat, in both the above cases one Injera is baked at a time. A few people mainly in North America patented automated machines to manufacture Injera: U.S. Pat. No. 7,421,943 (Yoseph) describes Injera baking machine, U.S. Pat. No. 7,063,008 and a Canadian Pat. No. CA 2415621 (Wundeb) describes Injera manufacturing system, and U.S. Pat. Application Publication No. 2005/0208183 (Emru) describes method of and apparatus for making Ethiopian bread, U.S. Pat. Application Publication No. 2003/0143309 (Mengistu Kindie et. al) describes Method and Apparatus for Making Bread, U.S. Pat. Application Publication No. 2011/0189361A1 (Wassie Mulugeta) describes a Rotary Baking System and Method, U.S. Pat. Application Publication No. 2012/0247344 A1 (Michael Ma) describes Method and Apparatus for Rapid Production of Injera Bread.

Most of previously patented designs so far are not easily customizable to fit for both small and large flatbread manufacturing. Besides that only a handful of automated machines are constructed in the world to solve Injera baking challenges that many Ethiopians encountered. People are still baking Injera in one at a time fashion. The process is very time consuming and less safer from hygienic point of view as Injera baking process involves much hand using from the beginning to the end.

It is a general objective of this invention to provide an improved, fully automated machine for manufacturing of Injera in a relatively small spaces, less costly and less human interference. The machine is capable of producing multiple Injera pieces continuously. The design of the machine is easily customizable to fit small to very large quantities Injera manufacturing.

### BRIEF DESCRIPTION OF THE DRAWINGS

This invention will be better understood from the following detailed description taken in conjunction with the accompanying drawings, wherein:

FIG. 1 is a perspective schematic view of the machine showing all the main machine components with detailed A and B

FIG. 2 is a detailed perspective schematic view of batter dispensing unit from FIG. 1

FIG. 3 is a detailed perspective schematic view of lid carrier unit from FIG. 1

FIG. 4 is a perspective schematic view showing pan and lid

FIG. 5 is a perspective schematic view of the machine without batter dispensing unit, without lid carrier unit, without machine top support to show detailed C, D of pans rotating unit

FIG. 6 is a detailed perspective schematic view from FIG. 5 showing pan rotating unit on left

FIG. 7 is a detailed perspective schematic view from FIG. 5 showing pan rotating unit on right

FIG. 8 is an exploded perspective schematic view of the machine showing all the machine parts

### DETAILED DESCRIPTION OF INVENTION

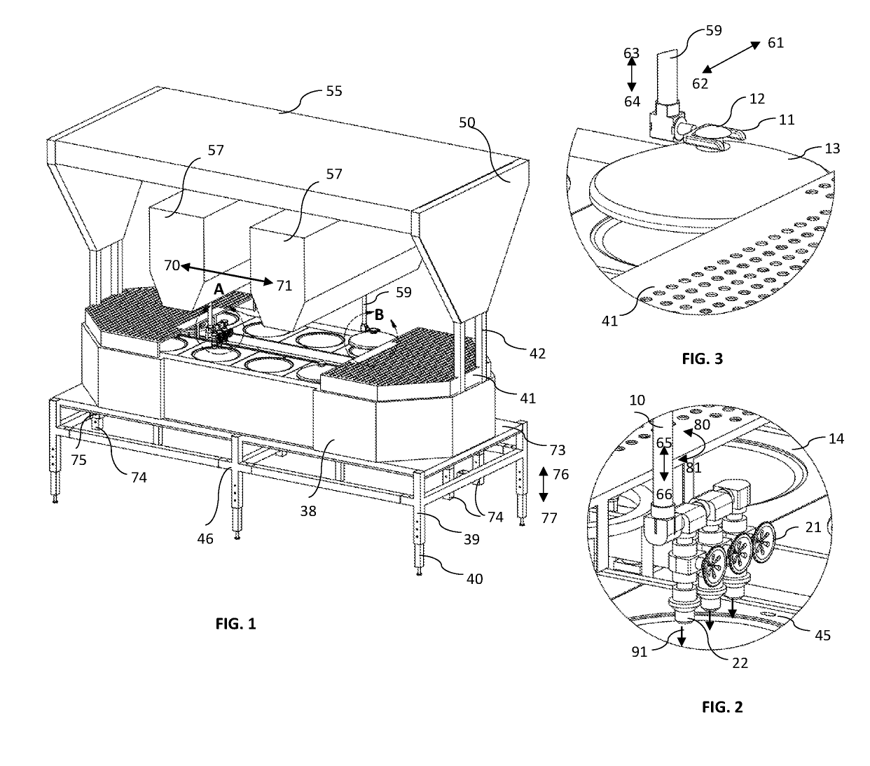

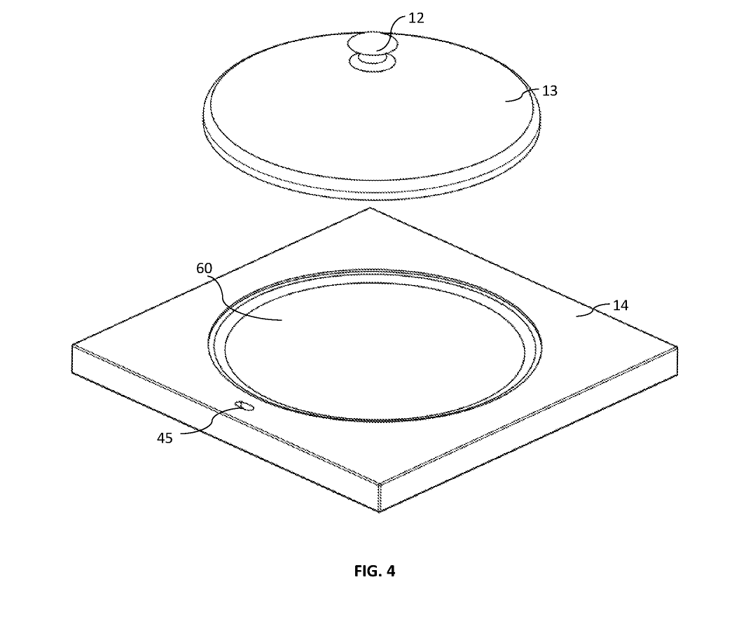

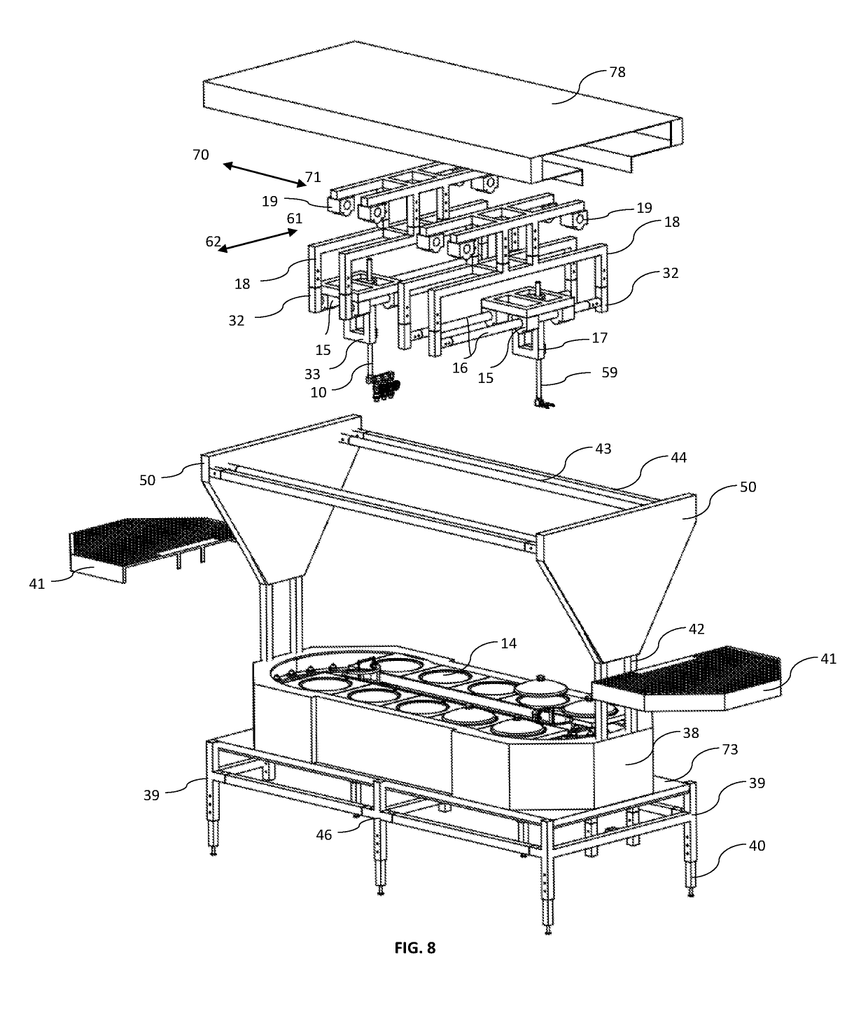

A combined description of FIG. 1 through FIG. 8 is done for better understanding of the present invention. FIG. 1, FIG. 2, FIG. 3 shows rotary baking pans configuration for mass manufacturing of Injera and different components of the present invention. The machine comprises of batter dispensering unit 22,21, 10, the batter dispensing unit 22,21,10 is attached to vertical linear bearing and the machine support frame 17, the nozzle 22 support 10 is attached to y-bearing and a motor can rotate the dispensing unit 21,22 in a clockwise 81 or anti-clockwise 80 direction. The support frame 17 is attached to linear bearings 15. In stationary pans 14 configuration, a motor can attach to the frame 17 to move the dispensing unit 21, 20, 10 forward 62,34 and backward 61,35 to align the unit 22,21 with different pans 14. The motor on bar 10 rotates 80, 81 to spread batter on different pan 14 surfaces 60. The lid carrier unit 11,59 connects to frame 33 that in turn connects to frames 32, 18. FIG. 4 the baking pan 14 has a rectangular shape with concave shape depression 60 on the center of the pan 14, the rim of the concave shape depression 60 allows baking of thinner flatbread on the periphery. The elliptical grooves on the pans 45 allow smooth rotation of the pans 14 at both end of the machine. The lids 13 with handle 12 cover some of the pans 14 when baking commences. FIG. 2 the batter dispensing unit 22, 21, 10 has nozzles 22 which are attached to each other side by side and each nozzles have flow control 21 valves to control the amount of batter coming out of the nozzles 22. Even though only three nozzles 22 are shown in the drawing, more nozzles 22 might be added as required during manufacturing of the machine. The nozzles 22 have different flow rates 91 to account for the differences in surface areas each nozzles 22 need to cover when rotating to spread batter, so nozzle 22 close to the center of the pan 14 means nozzle 22 close to support bar 10 have lower flow rate 91 as compared to nozzle 22 away from the center of the pan 14. The nozzle support 10 rotates either to clockwise 81 or anti-clockwise 80 direction to spread batter on baking surface 60, the nozzle 22, 21 spreads batter in a circular shape. Even though nozzles 22 covers a radius of the pan 14, during manufacturing more nozzles 22 might be added to cover a diameter of the pan 60 so that the nozzles 22 rotates only 180 degrees to dispense batter instead of 360 degrees. FIG. 3, the lid carrier unit has a support arm 59, y-shaped bars 11 to hold the lid 13 up 63 and move it to the opposite 62 side of the machine and drop 64 the lid on another baking surface 14, then move back 61 to the original place to pick 63 another lid 13. The machine has two rows of pans 14. FIG. 2, FIG. 3, an elliptical pin 51 on spring 49 loaded bar 48 enters the groove 45 on the pan 14, as bar 48 rotates 68, the elliptical pin 51 pushes down 93 by a spring 49 that force the pin 51 to lock in the groove 45. Rotation of the pin 51 forces the pan 14 to rotate to the opposite row, a wedge shape 78 tip on each side of the crescent shaped bar 47 pushes the pin 52 up 92 so that the pin 51 unlocks from the groove 45. The crescent shaped bar 47 is connected to the machine body with bar 91. A protection covers 41 are connected to each side of the machine to reduce accidents which may cause by rotation 68 of the pans 14 from one side of the machine to another.

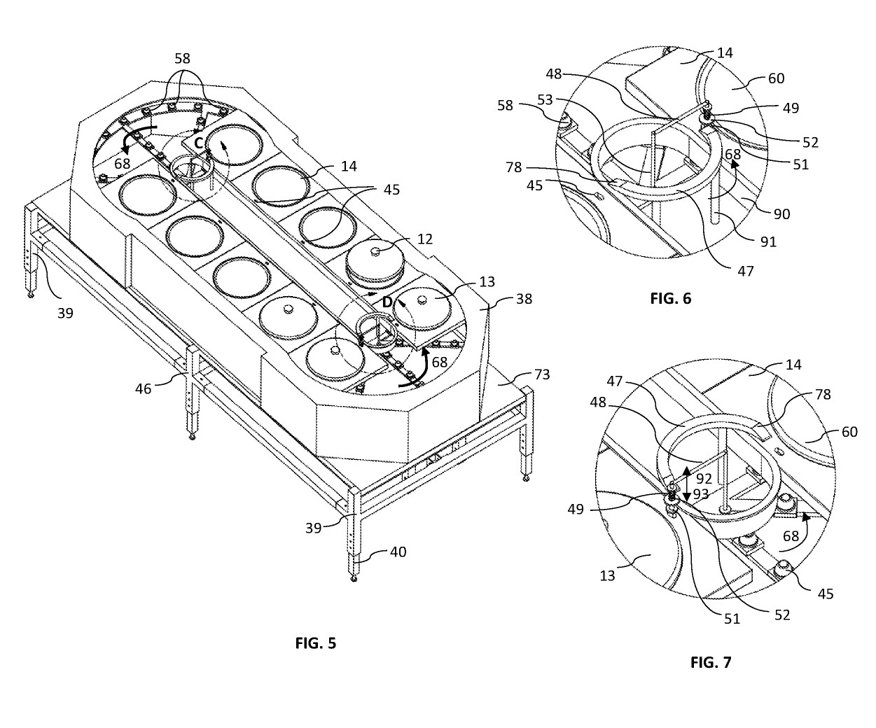

FIG. 5, for smooth sliding of the pans 14, roller bearings 58 mounted on the machine support frames to carry the pans 14, the roller bearings 58 support frames are mounted inside the machine body 38, the body 38 attached to the machine bottom support frames 39, 40,46,73, 74,75, telescoping mechanism between bar 40 and bar 39 allows machine height adjustment. Both the lid carrier unit 11, 59 and batter dispensing unit 22,21,10 are connected to the machine main frames 17,33,32,18,32 which are covered by metal sheets 57, 55, frames 42 on both side of the machine support all the top machine parts 57,55. Additional support frames 44 give additional support for the top machine part by connecting frames 42 on both side of the machine.

FIG. 8, the batter dispensing unit 22, 21, 10 is attached to the machine support top frame 17, the dispensing unit bar 10 is attached to y-bearing and a motor rotates the dispensing unit 21 in a clockwise 81 or anti-clockwise 80 direction. The bar 10 is connected to vertical linear bearing and support frames 17. The support frames 17 is attached to linear bearings 15, a motor can attach to the frame 17 to move the dispensing unit 21, 20, 10 forward 34 62 and backward 35,61 to spread batter on different pans surfaces 60. The linear bearings 15 on frame 17 can slide on cylindrical bar 16, the cylindrical bar 16 are attached to another frames 32, 18, the top frames 18 have linear bearings 19 which are aligned in the machine longitudinal direction. The linear bearings 19 slides on cylindrical bars 43, and motor with belt or chain system may attach to both end of the machine frame 50 and frame 18 to control the lateral movement 70,71 of dispensing unit 22,21,10 and also the lateral movement 70,71 of lid carrier unit 11,59. Both the dispensing unit 22, 21, 10 and lid carrier unit 11, 59 can move separately. In rotary pans 14 configuration, the dispensing unit 22, 21, 10 is stationary in one place and the lid carrier unit 11, 59 moves from one side of the machine to another to pick 63 pan 14 from the back side 61 of the machine and drop 64 the pan 14 to the front side 62. Where are in the stationary pans 14 configuration, the dispensing unit 22,21,10 moves from pan 14 to pan 14, from front 62 to back 61 to dispense batter, and the lid carrier unit 59,11 moves from pan 14 to pan 14 and from front 62 to back 61 to move lids 13. None-stick coat such as PTFE or ceramic coat is applied on pan surfaces 60. PTFE can withstand a maximum temperature of up to 350 C and the Injera batter can bake well within a minute at this temperature.

The connections, parts/components, methods mentioned in this invention are well known in the field of the invention and may easily be understandable by person skilled in the art of science, so details of connections, parts/components, methods are not discussed in very detail.

The invention shown from FIG. 1 to FIG. 8 and the above detailed description of the invention shown are the preferred method of Injera manufacturing. In this invention, modification, re-arranging, alteration of different parts in the Injera manufacturing machine may be made within the scope of the invention.

1. A compact machine for manufacturing of flatbread mainly Ethiopian circular, thin, flatbread comprising:
A movable batter dispensing unit, baking pans, lids, movable lid picking arm for transferring of lids, pans rotating mechanism. The movable batter deposition unit has nozzles with flow control mechanism. The machine as two configuration namely stationary baking pans configuration and rotary baking pans configuration

2. The compact machine for manufacturing of flatbread as set forth in claim 1, wherein said Injera machine has two configurations: stationary baking pans configuration and rotary baking pans configuration

3. The compact machine for manufacturing of flatbread as set forth in claim 1, wherein said Injera machine has batter dispenser that has nozzles with flow control mechanism to control the Injera thickness and width. The batter dispenser rotates to spread Inera batter on to the baking pans

4. The machine for manufacturing of flatbread as set forth in claim 1, wherein said Injera machine has batter dispenser unit that can move on three axes: back-forth, left-right and upward-downward

5. The machine for manufacturing of flatbread as set forth in claim 1, wherein said Injera machine has a lid carrier unit that can move on three axes: back-forth, left-right and upward-downward

6. The machine for manufacturing of flatbread as set forth in claim 5, wherein said Injera machine has y-shaped horizontal mechanical arm to pick a lid from one side of the machine to another

7. The machine for manufacturing of flatbread as set forth in claim 1, wherein said Injera machine has elliptical shape pins to lock in pan groove and rotates baking pans from one side of the machine to another

8. The machine for manufacturing of flatbread as set forth in claim 1, wherein said Injera machine baking pans have elliptical grooves to fit with elliptical pins for rotation

9. The machine for manufacturing of flatbread as set forth in claim 1, wherein said Injera machine has two crescent shaped metal bars to unlock the elliptical pins from the pan grooves
